(19) United States
(12) Patent Application Publication
(10) Pub. No.: US 2011/0214085 A1
(43) Pub. Date: Sep. 1, 2011

(54) Method of user display associated with displaying registered images

(76) Inventor: Ken Vanbree, Mountain View, CA (US)

(21) Appl. No.: 13/068,240

(22) Filed: May 6, 2011

Related U.S. Application Data
(63) Continuation-in-part of application No. 11/021,655, filed on Dec. 23, 2004, now Pat. No. 7,966,563.

(51) Int. Cl. G06F 3/048

(52) U.S. Cl. 715/781

(57) ABSTRACT

The invention provides a means for a User to enter a structure/building under construction, on a computer enabled device, display a 2D floorplan or map of the realworld [3D] structure in which User is standing, and User can indicate on the display, via a mouseclick, for example, the User's approximation of User's realworld location. Then, User can acquire an image, and the display will indicate to User how to more accurately select the position from which the image was acquired. The information—i.e. both the acquired image and the imaging position information on the floorplan—can be stored, and retrieved and re-displayed, by clicking the interactive floorplan of the structure.

In an alternate embodiment, the invention provides that in addition to an acquired image, User may retrieve a reference image, and compare the acquired image with the reference image, and refine the position indicator on the interactive display of the floorplan, where the precision is sufficient to enable a Thru-view™ display.

### RELATED APPLICATIONS

This application is a continuation in part of allowed U.S. patent application Ser. No. 11/021,655, entitled “System for Organizing and Displaying Registered Images” by the same inventor.

### BACKGROUND

The invention of U.S. patent application Ser. No. 11/021,655 describes how a user interface can enable a user to quickly locate images taken at particular precise geographic locations (called a viewport) and then compare images taken from that viewport at different times with different imaging devices. The images displayed through the interface of U.S. patent application Ser. No. 11/021,655 can be captured by an imaging device using visible light or they can be thermal heat-maps captured by an infrared imaging device or they can be captured by a virtual imaging device within a model of the space surrounding the viewport.

There is an unmet need for a way to simply capture and display images from precise geographic locations. Without such a capability the number of images taken at a construction site can quickly overwhelm their usefulness by making it difficult or impossible to determine which image belongs to which part of the construction project. Images that are taken during construction of a complex building are valuable to builders during the construction process when changes are required or questions arise about details of the construction process. The same images are valuable to owners who maintain and modify buildings over their useful lifetime.

There is a further unmet need for a way to easily capture and display images taken from precise geographic locations with other similar images taken at different times or with different imaging techniques.

### BRIEF SUMMARY OF THE INVENTION

The invention taught herein meets at least all of the recited unmet needs. The invention provides a method that enables a User to enter a structure/building under construction, on a computer enabled device, display a floorplan or map of the realworld structure in which User is standing, and User can indicate on the display, via a mouseclick, for example, the User's approximation of User's realworld location. Then, User can acquire an image, and the display will indicate to User how to more accurately select the position from which the image was acquired. The information—i.e. both the acquired image and the imaging position information on the floorplan—can be stored, and retrieved and re-displayed, by mousing over or clicking the interactive floorplan of the structure.

In an alternate embodiment, the invention provides that in addition to an acquired image, User may retrieve a reference image, and compare the acquired image with the reference image, and refine the position indicator on the interactive display of the floorplan, where the precision is sufficient to enable a thru-view display.

### BRIEF DESCRIPTION OF THE DRAWINGS

The following drawings are provided as an aid to understanding the invention:

FIG. 1A is a flow chart that depicts the steps of a method according to the invention.

FIG. 1B is a flow chart that depicts the steps of an alternate embodiment of a method according to the invention.

FIG. 2 depicts a displayed floor plan, an area of interest, and a selected imaging position on the floor plan.

FIG. 3 depicts a selected imaging direction in the floorplan of interest (of FIG. 2).

FIG. 4 depicts a displayed acquired image and a first viewport.

FIG. 5 depicts a displayed acquired image and an adjusted imaging position and direction, comprising an adjusted viewport.

FIG. 6 depicts a displayed floorplan, where the display includes data pertaining to real world features (e.g. heights, distances).

FIG. 7 depicts the floorplan of FIG. 5, including a viewport.

FIG. 8 depicts the floorplan of FIGS. 6 and 7, where the viewport has been adjusted to properly indicate the position & direction from which the displayed image had been taken.

FIG. 9 depicts a displayed foorplan and a reference image.

FIG. 10 depicts a displayed floorplan and a current image taken to match the position and direction of the reference image.

FIG. 11 depicts a display with a Thru-view.

### DETAILED DESCRIPTION OF A PREFERRED EMBODIMENT

The invention provides a means to display to the User a floorplan of interest and a fairly accurate indication and storage of a viewport, stored and retrievable along with any images associated with that viewport, where the viewport appears as an icon on a depiction of the floorplan displayed to User.

In an alternate embodiment the invention provides a means to precisely align images taken from viewports as represented on the floor plan displayed to User, so that a thru-view viewing is possible, as taught in another US patent (entitled “System for Accurately Repositioning Imaging Devices”)

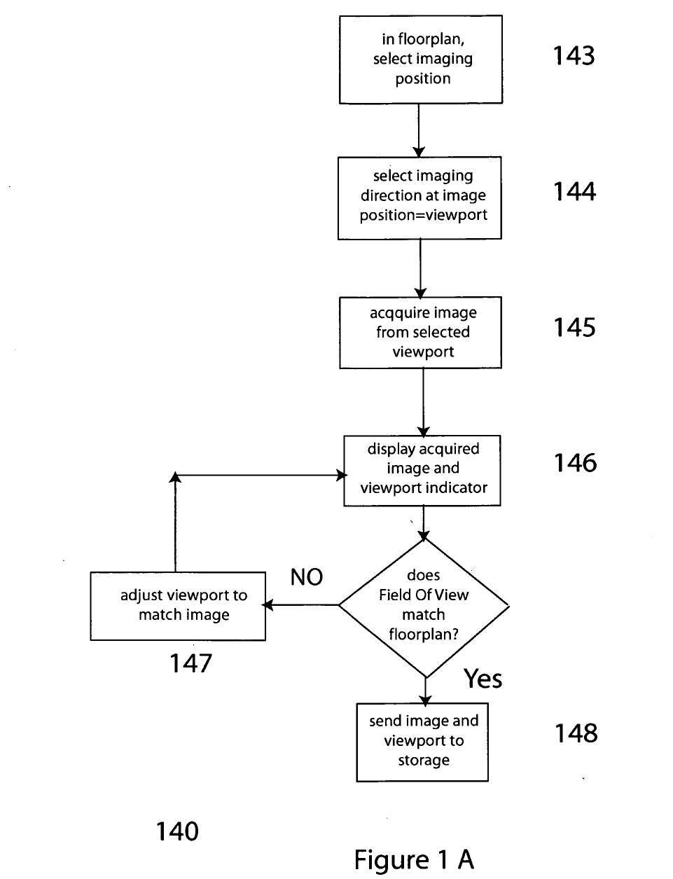

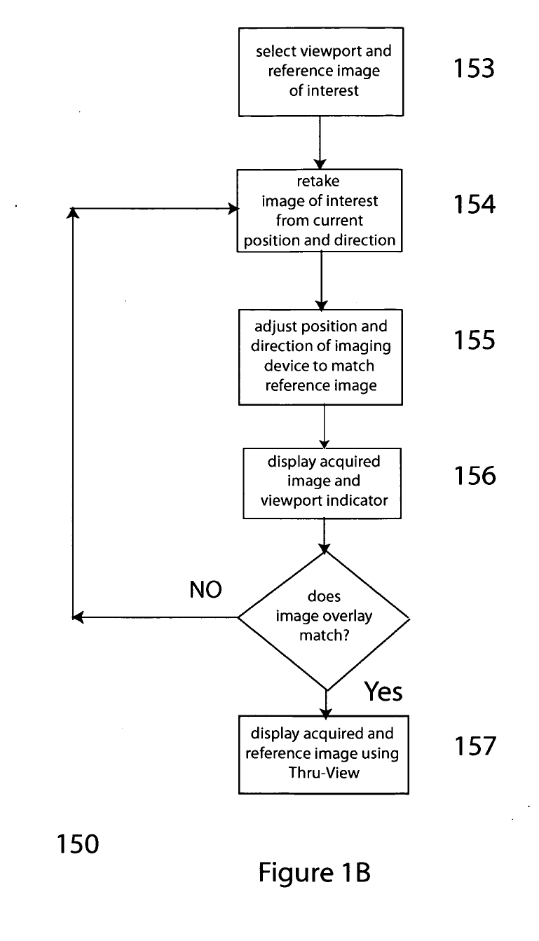

Referring now to FIG. 1A a preferred embodiment of the invention provides the method 140 which comprises the step of:

selecting a floorplan, and an area of interest on floor plan, and selecting a first imaging position within the floor plan 143;
selecting a first imaging direction at a first imaging position 144, which comprise a viewport;
acquiring image from location corresponding to the viewport of the preceding step 145;
displaying the acquired image and viewport direction and position on the floorplan 146;
adjusting, as necessary, the viewport direction and position to match the acquired image 147;
storing the acquired image and the adjusted viewport 148 (associated with the floorplan), such that User may select viewport indicator displayed on the floorplan, and, associated with the stored viewport, and the acquired image will be displayed to User.

It must be noted that a viewport, according to the invention, is more than just a direction and position. A viewport can allow access to any number of images (including none) taken at the imaging position and the imaging direction, which are taken at different times by different imaging devices. For greater discussion on viewport, please refer to the related U.S. application Ser. No. 11/021,655, entitled “System for Organizing and Displaying Registered Images” by the same inventor. Also, the term “field of view” as used herein has the meaning used in U.S. application Ser. No. 11/021,655.

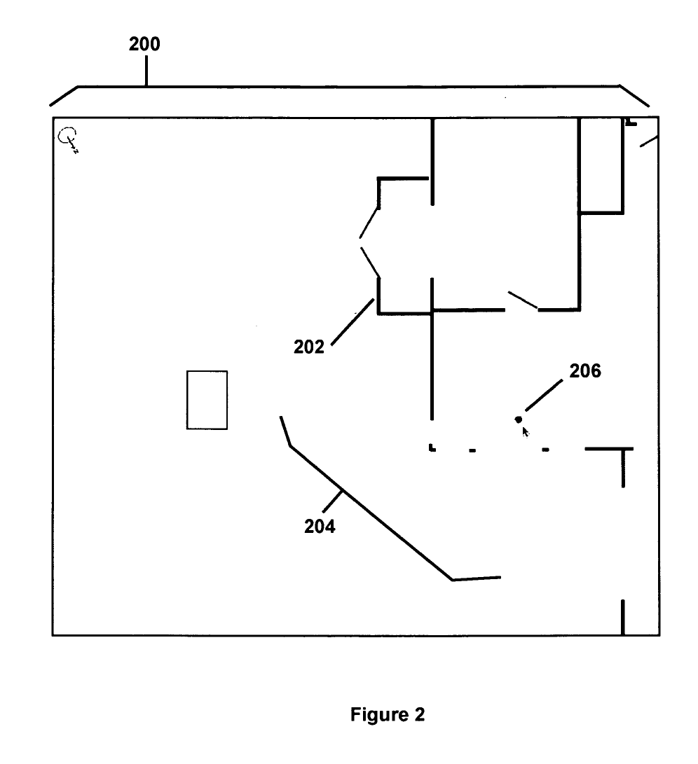

As can be appreciated by referring to FIG. 2, which depicts a screen shot 200 of a GUI according to the invention, in a floor plan displayed to User, some first imaging position 201 is selected. In one embodiment, User can click on the displayed floor plan, and the selected location, representing what User opines to be User's approximate location in the building under construction.

FIG. 2 depicts a GUI screenshot 200 that includes displayed floor plan 202, an area of interest 204, and a selected imaging position on the floor plan 206.

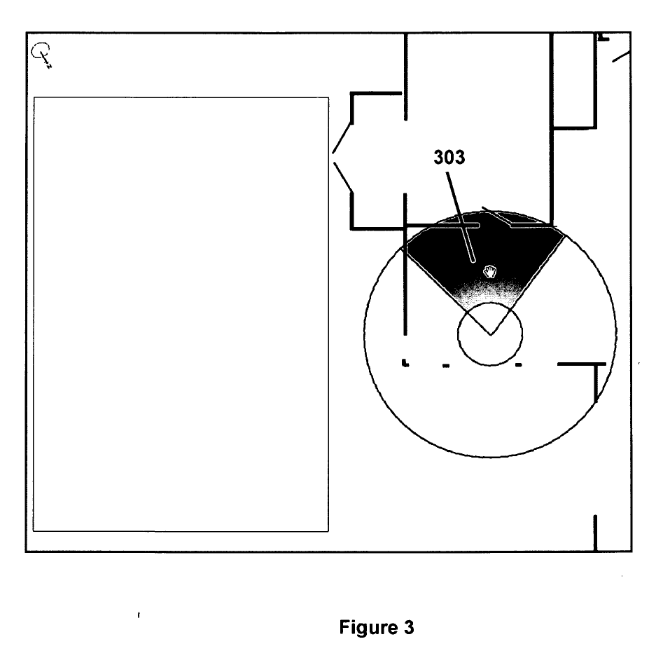

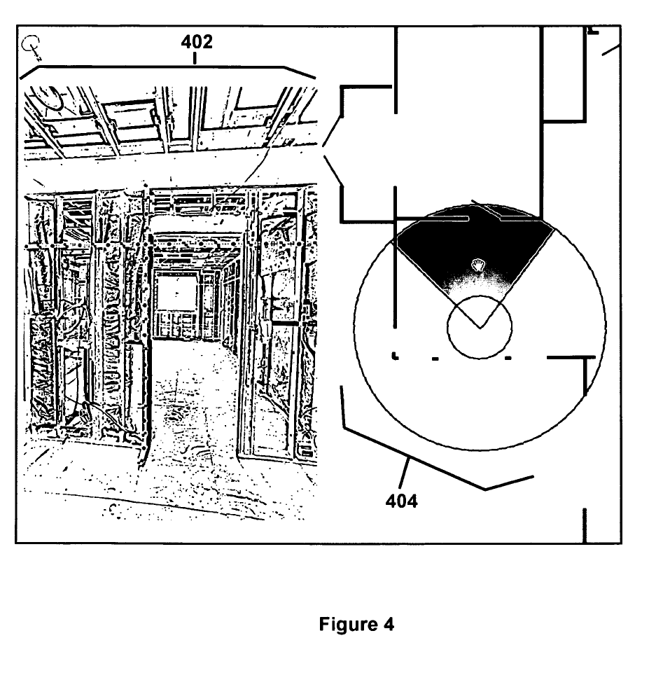

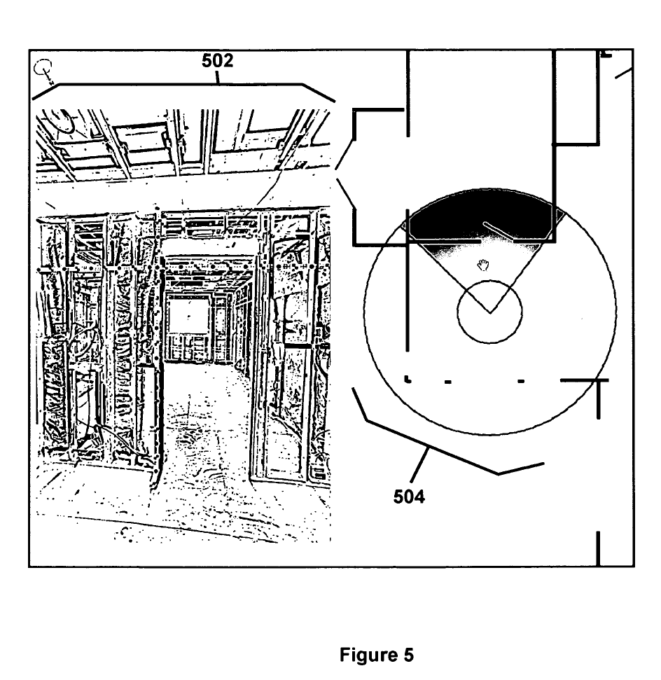

FIG. 3 depicts a selected imaging direction 303 in the floorplan of interest (202 of FIG. 2). FIG. 4 depicts a displayed acquired image 402 and a first viewport 404 (sometimes referred to herein as a viewport indicator).
FIG. 5 depicts a displayed acquired image 502 and an adjusted imaging position and direction, comprising an adjusted viewport 504.

Referring now to FIG. 1B, in an alternate embodiment of the invention, the method comprises the steps of:

selecting a viewport and reference image of interest 153;
re-taking image of interest from current position and direction 154;
adjusting position and direction of imaging device to “match” reference image using system patent (U.S. Pat. No. 7,688,381) 155, and repeating steps 154 and 155 until overlay matches;
displaying acquired image from step 154 and viewport indicator (as taught by allowed U.S. application Ser. No. 11/021,655) 156; and
displaying acquired image and reference image from step 153 (using Thru-view™ as taught by allowed U.S. application Ser. No. 11/021,655) 157. Thru-view™ is a trademark of Imaging Perspective LLC, a California Limited Liability Corporation.

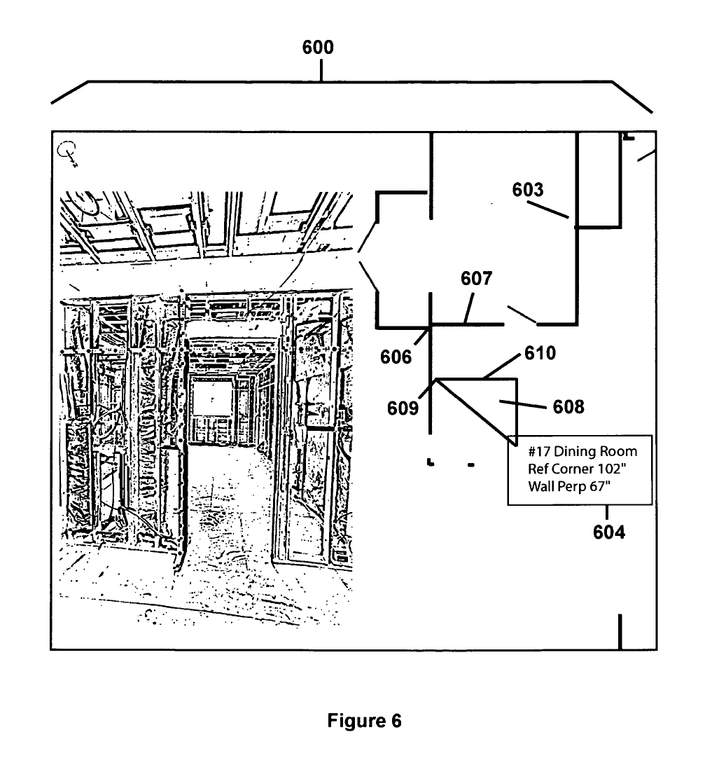

FIG. 6 depicts a screen shot of a GUI 600, including a displayed floorplan 603, where the display includes data pertaining to real world features (e.g. heights, distances) 604. This data can be acquired by the User and input to the interface or it can be retrieved from storage or extracted from an acquired image as described in system patent U.S. Pat. No. 7,688,381. FIG. 6 also contains a reference corner 606, a reference wall 607, and a measurement triangle 608. The measurement triangle of FIG. 6 has a reference vertex 609 and a reference direction 610.

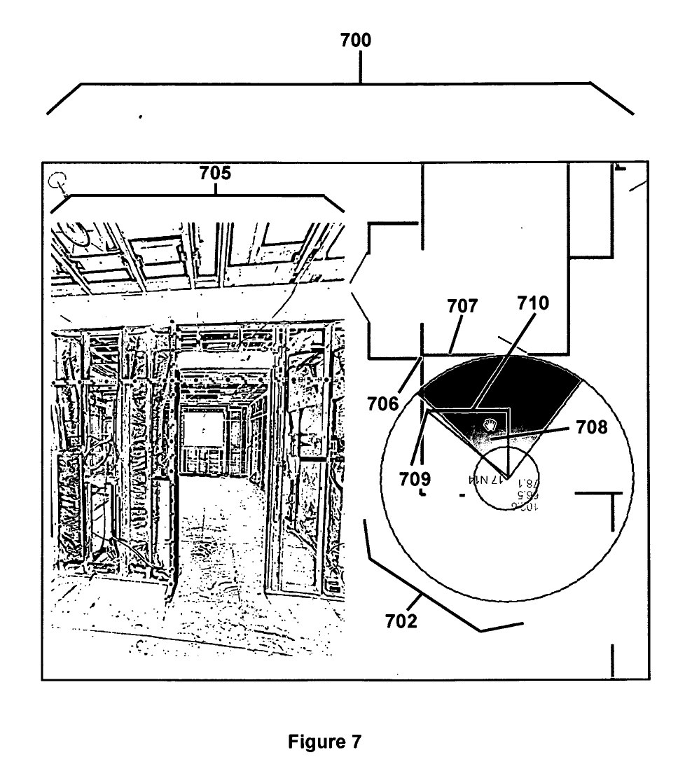

FIG. 7 depicts a screen shot 700 of a GUI displaying the floorplan of FIG. 6, including a viewport 702, an acquired image 705, a reference corner 706, a reference wall 707, a measurement triangle 708, a reference vertex on the measurement triangle 709, and a reference direction 710.

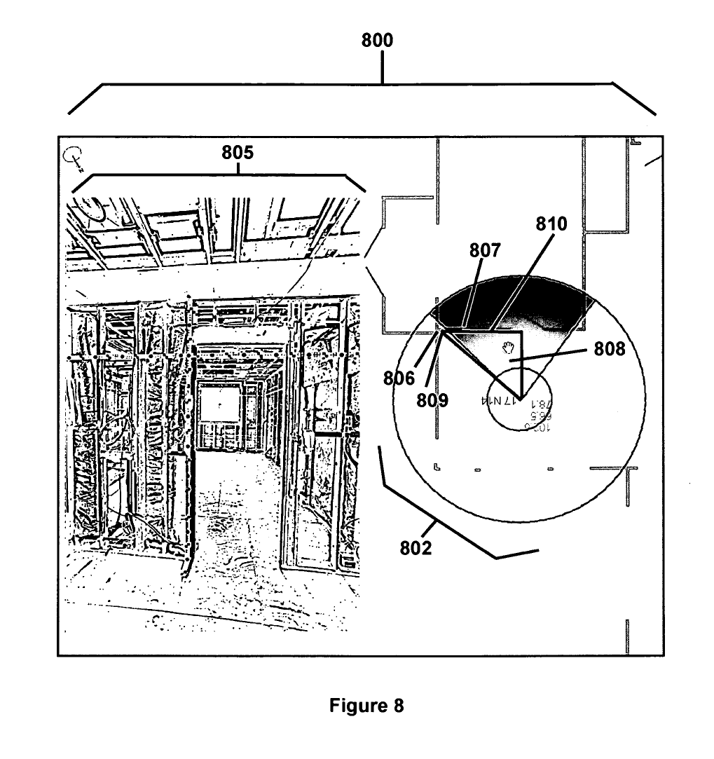

FIG. 8 depicts a screenshot 800 of a GUI displaying the floorplan of FIGS. 6 and 7, where the viewport 702 has been adjusted to properly indicate the position and direction from which the displayed image had been taken (i.e. adjusted viewport 802) The position of the measurement triangle 808 has been adjusted such that the reference vertex 809 overlays the reference corner 806 and the reference direction 810 overlays the reference wall 807. In this way the viewport 802 has been adjusted to properly indicate the position and direction from which the acquired image 805 was taken.

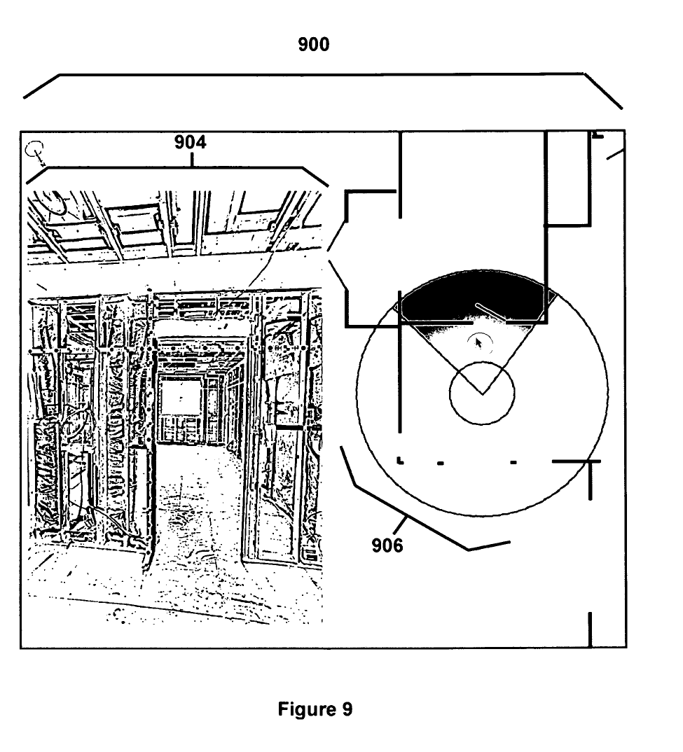

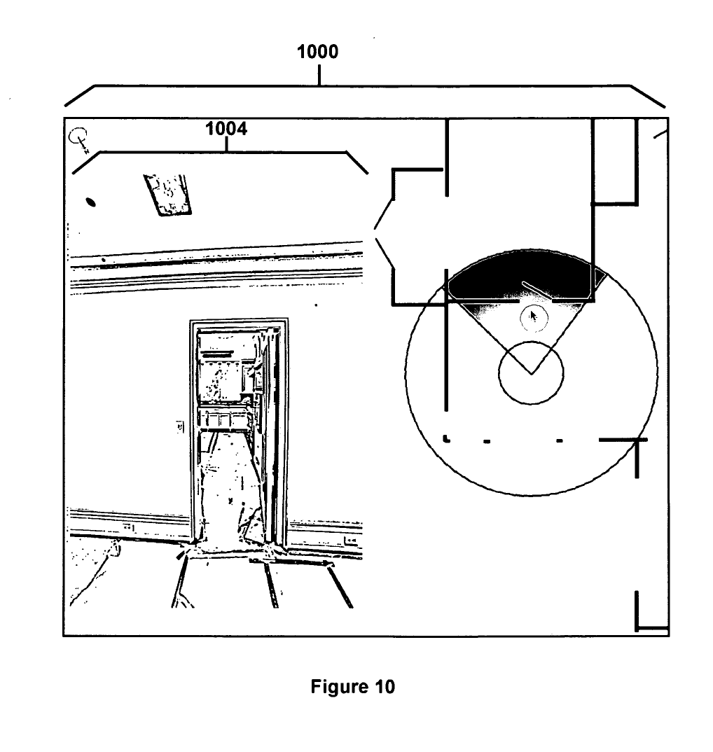

FIG. 9 depicts a screen shot 900 of a GUI displaying a floorplan and a reference image 904 selected from the viewport 906. FIG. 10 depicts a screen shot of a GUI 1000 displaying the floorplan and a current image 1004 taken to match the position and direction of the reference image 904 in FIG. 9. The current image 1004 can be taken with or without the aid of the measurement triangle shown as 708 in FIGS. 7 and 808 in FIG. 8.

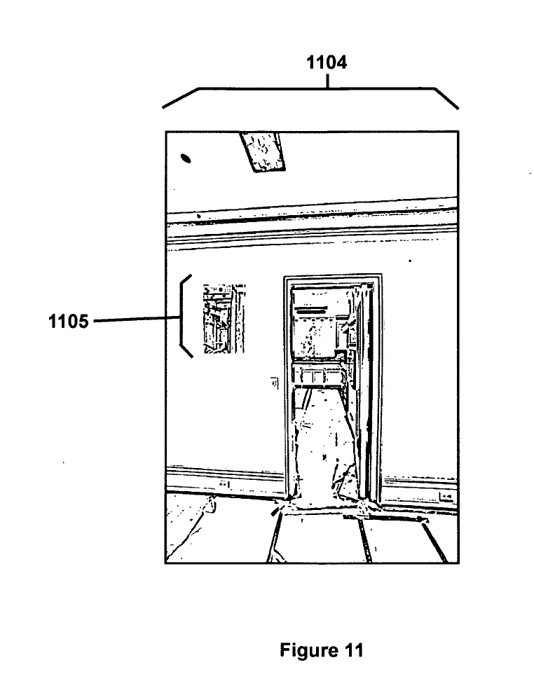

FIG. 11 depicts a screenshot of a GUI 1104 displaying a Thru-view window 1105 where a portion of reference image 904 from FIG. 9 appears within current image 1004 from FIG. 10. The operation of the Thru-view window of FIG. 11 is taught in U.S. patent application Ser. No. 11/021,655, entitled “System for Organizing and Displaying Registered Images”.

It can be appreciated that the scope of invention taught herein is intended to include the full scope of the claims and the equivalents thereunder, as well as this specification and the drawings filed herewith.

I claim:

1. A method, said method implemented by using a computer enabled display device, equipped with a CPU, memory, and a user interface, the method comprises the step of:
selecting a floorplan, and an area of interest on said floor plan, and selecting a first imaging position within said floor plan;
selecting a first imaging direction at said first imaging position, which comprise a viewport;
acquiring image from said viewport of the preceding step;
displaying said acquired image and viewport, direction and position, on said floorplan;
adjusting, as necessary, said viewport direction and position to match said acquired image; and
storing said acquired image and said adjusted viewport, such that User may select viewport indicator displayed on said floorplan, and, associated with said stored viewport, and said acquired image will be displayed to User.

2. A method, said method implemented by using a computer enabled display device, equipped with a CPU, memory, and a user interface, the method comprises the step of:
selecting a viewport and reference image of interest;
re-taking image of interest from current position and direction;
adjusting position and direction of imaging device to “match” reference image and repeating the steps of taking images and adjusting as needed to produce an acquired image that overlays the reference image;
displaying acquired image and viewport indicator; and
displaying acquired image and reference image using Thru-view.

3. The method of claim 2, wherein said step of matching said overlay further includes the substeps of:
inputting measurement data, where said measurement data aids in precise locating of viewpoint.
